(19) United States
(12) Patent Application Publication
(10) Pub. No.: US 2026/0320063 A1
(43) Pub. Date: Oct. 15, 2026

(54) COMPUTER-IMPLEMENTED SYSTEM AND METHOD FOR MULTI-LINEAGE OVERLAP DETECTION, ROYAL LINEAGE VERIFICATION

(71) Applicant: Brandon McDonald, Fremont, MI (US)

(72) Inventor: Brandon McDonald, Fremont, MI (US)

(21) Appl. No.: 19/644,460

(22) Filed: Apr. 10, 2026

Related U.S. Application Data
(60) Provisional application No. 63/787,969, filed on Apr. 13, 2025.

(51) Int. Cl. G06F 16/2458; G06F 16/23; G06F 16/28; G06F 18/21

(52) U.S. Cl. CPC G06F 16/2465; G06F 16/23; G06F 16/287; G06F 18/217

(57) ABSTRACT

A system, method, and non-transitory computer-readable medium for determining ancestral relationships and generating lineage-density evaluations. The invention integrates genetic, genealogical, personal narrative, and historical data to identify overlap among ancestral entities and calculate lineage-density values (LDI) indicative of relational proximity between a person of interest and one or more population groups, including dynastic or royal lineages. A computing system normalizes input data, detects shared ancestry using probabilistic and rule-based models, and correlates genetic markers with reference datasets to produce confidence scores of probable lineage. An adaptive feedback and training process refines model parameters and confidence weights as verified data or user corrections are received. Results are presented through visualizations and reports that display LDI metrics, inferred dynastic associations, and corresponding confidence levels.

### CROSS REFERENCE TO RELATED APPLICATIONS

This application claims the benefit of U.S. Provisional Patent Application No. 63/787,969, filed Apr. 13, 2025, under 35 U.S.C. § 119(e). The entire disclosure of the provisional application, including but not limited to the specification and drawings, is hereby incorporated by reference in its entirety as if fully set forth herein.

### FIELD

The subject matter disclosed herein relates generally to computer-implemented genealogical analysis systems and methods, and more particularly to systems and methods for integrating genealogical, genetic, and historical datasets to identify, quantify, and verify lineage connections. In certain embodiments, the disclosure provides a computer-implemented framework for detecting multi-lineage overlaps, computing a royal-lineage density index, and generating verified ancestry visualizations using artificial intelligence and machine learning techniques.

### BACKGROUND

Genealogical and genetic analysis systems are used to study familial relationships and ancestral origins. Existing systems typically analyze either genealogical data or genetic data but often lack integrated frameworks that can quantify and verify multi-lineage relationships across both domains.

Accordingly, there is a need for improved computer-implemented systems and methods capable of combining genealogical, genetic, and historical data to detect lineage overlaps, compute lineage density metrics, and generate verifiable ancestry outputs.

### BRIEF SUMMARY

The present disclosure provides systems, methods, and computer-readable media for analyzing and verifying ancestral relationships through the integration of genetic, genealogical, narrative, and historical data. In one embodiment, a computing system receives data associated with a person of interest, normalizes the data into a consistent structure, and identifies overlaps among ancestral entities. The system computes lineage-density values representing the degree of ancestral convergence toward one or more reference populations or dynasties and correlates genetic markers with stored reference data to generate confidence scores indicating probable lineage relationships.

The disclosure further includes adaptive learning and feedback mechanisms that update weighting parameters, refine correlation models, and adjust scoring logic based on verified results or user input. Analytical outputs, including graphical lineage maps, density indices, and confidence summaries, are generated for visualization and archival storage. Through this iterative and data-driven approach, the system enables objective, repeatable, and evidence-based determination of ancestral and dynastic lineage connections.

### BRIEF DESCRIPTION OF THE DRAWINGS

The following drawings illustrate by way of example and are included to provide further understanding of the disclosure for purpose of illustration. No attempt is made to show structural details of the embodiments in more detail than is necessary for a fundamental understanding of the disclosure, the description taken with the drawings making apparent to those skilled in the art how the several forms of the disclosed system, method, and non-transitory computer readable media may be embodied in practice. Identical reference numerals do not necessarily indicate an identical structure. Rather, the same reference numeral may be used to indicate a similar feature or a feature with similar functionality. In the drawings:

FIG. 1 is a block diagram illustrating an exemplary networked architecture of an ancestral overlap detection and visualization system configured to receive genealogical and genetic data.

FIG. 2 is a flow diagram illustrating an exemplary operational process for multi-lineage overlap detection, royal-density computation, and verified ancestry generation.

FIG. 3 is a functional block diagram illustrating internal modules of the ancestral overlap detection and visualization system.

FIG. 4 is a diagram illustrating exemplary data flow and visualization generation for royal-lineage density analysis and reporting.

FIG. 5 is a block diagram illustrating an exemplary feedback and machine-learning refinement loop for improving lineage verification accuracy.

FIG. 6 is a flow diagram illustrating exemplary analytical computation and visualization of a royal-density index and confidence-scoring model.

FIG. 7 is a diagram illustrating an exemplary end-to-end user interaction flow and output generation process of the royal lineage discovery system.

FIG. 8 is a data-relationship diagram illustrating an exemplary data architecture for implementing royal-lineage overlap detection and density computation.

### DETAILED DESCRIPTION

The following detailed description is provided to enable those skilled in the art to make and use the system, method, and non-transitory computer readable media and is not intended to limit the scope of the claims. The embodiments described herein are presented by way of example only, with reference to the accompanying drawings, and it will be understood that various modifications, substitutions, and equivalents may be employed without departing from the spirit and scope of the disclosure. Unless otherwise indicated, the same reference numbers are used throughout the drawings to refer to the same or similar elements. The system may be embodied in hardware, software, firmware, or combinations thereof implemented on one or more computing devices. For clarity of explanation, the following description references a representative embodiment of a computer-implemented Royal Lineage Discovery System configured to detect multi-lineage overlaps, compute royal-density indices, and generate verified ancestry visualizations.

The disclosed system may be implemented as a structured analytical workflow comprising sequential and iterative stages of data ingestion, normalization, overlap detection, lineage-density computation, genetic validation, and multi-lineage convergence analysis. In certain embodiments, portions of the workflow may include user-guided analytical steps in combination with automated computation, forming a hybrid human-machine methodology for lineage discovery and validation.

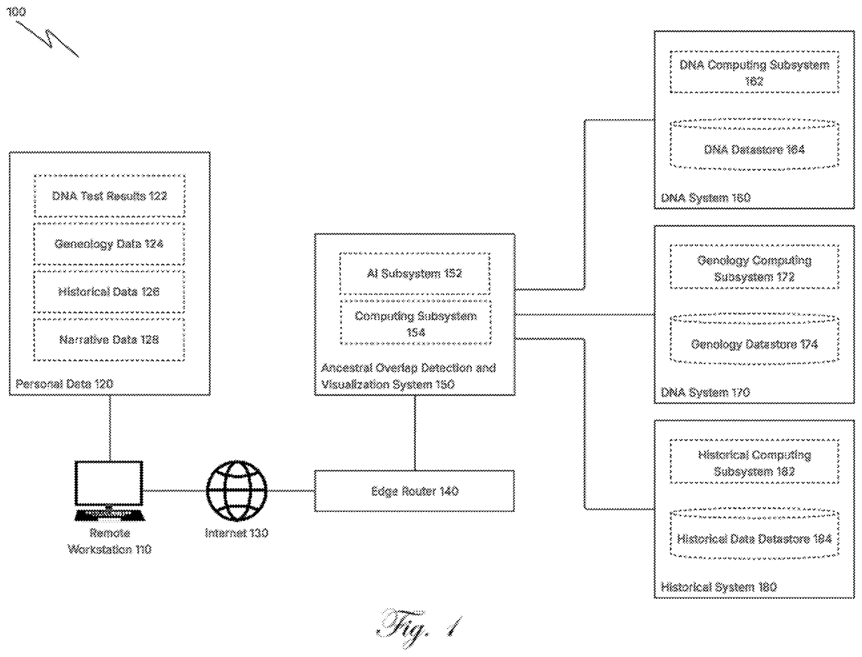

Referring now to FIG. 1, an exemplary system architecture 100 for an Ancestral Overlap Detection and Visualization System 150 is shown. The architecture enables the secure acquisition, normalization, analysis, and visualization of genealogical, genetic, and historical data for royal-lineage discovery and verification. Unless otherwise indicated, like reference numerals refer to like elements throughout the drawings.

A remote workstation 110 communicates with system 150 either through the Internet 130 or via a local or direct connection. The workstation 110 may be any suitable computing device, including a desktop computer, laptop, thin client, tablet, or mobile phone executing browser-based or native client software. In certain embodiments, the workstation 110 is operated by a researcher, family member, or administrator entering data about another individual (i.e., the subject of interest need not be the device operator). In on-premises deployments, the workstation 110 may communicate with system 150 over a local area network without traversing the public Internet.

Workstation 110 provides or accesses personal data 120, which can include, without limitation: deoxyribonucleic acid (“DNA”) Test Results 122, Genealogy Data 124, Historical Data 126, and Narrative Data 128. Each of these data classes may be supplied as files, API payloads, or user-entered records, and may be stored temporarily or persistently by the system as described below.

The DNA Test Results 122 may comprise whole-genome or exome mappings, autosomal single nucleotide polymorphic (“SNP”) profiles, Y-chromosome short tandem repeat (“STR”) and SNP panels, mitochondrial haplogroup results, or other genetic datasets, including outputs obtained from third-party DNA testing services. In certain embodiments, DNA features may be inferred from medical histories, phenotypic observations, or reported health conditions (e.g., traits correlated with known markers). The system may record provenance and confidence values for inferred features and may treat inferred features differently from measured results during correlation.

The Genealogy Data 124 may include user-created charts (e.g., pedigree diagrams prepared by the user), tabular family registers, and/or imported structured files from external repositories. In particular embodiments, the system imports standardized genealogical data communication (“GEDCOM”) files. The system may parse GEDCOM to extract person records, parent-child links, events, and sources, and then normalize them into an internal schema for overlap analysis.

The Historical Data 126 may include documentary evidence such as birth certificates, baptismal records, marriage licenses, death certificates, census entries, land rolls, heraldic registers, court documents, or archival manuscripts. Historical Data 126 can also include dated publications or catalog entries that corroborate identities, dynastic affiliations, or locations. The system may ingest such evidence as images, portable document format (“PDF”) files, transcriptions, or structured citations with associated authenticity/confidence attributes.

The Narrative Data 128 may include family stories, recorded oral histories, or descriptive features about individuals or branches—e.g., reputed titles, coat-of-arms descriptions, migrations, or distinguishing traits. Narrative Data 128 can be used to guide searches, seed candidate matches, or annotate outputs. In certain embodiments, “narrative” also includes feature tags—e.g., “served in Household of X,” “ward of Y,” or “associated with Z manor”—that the AI subsystem can leverage as soft constraints during inference.

Personal data 120 are transmitted from the workstation 110 to the system 150 through an edge router 140 or another secure gateway. The edge router 140 manages session establishment, authentication, encryption—e.g., transport layer security (“TLS”)—network address translation, and routing between user devices and analytic subsystems. Communications may occur over secure hypertext transfer protocol (“HTTPS”), secure WebSocket, virtual private network (“VPN”), message-queue protocols, or other secure transports. In local deployments, the edge router 140 can be a logical component within the same host or subnet as system 150.

The Ancestral Overlap Detection and Visualization System 150 includes a computing subsystem 154 and an AI subsystem 152. The computing subsystem 154 comprises at least one processor operatively coupled to a memory and/or other non-transitory computer-readable media storing instructions that, when executed, cause the system to perform data ingestion, normalization, index construction, overlap detection, density computation, correlation, visualization generation, and report creation as described herein. Storage may include volatile memory, solid-state drives, magnetic media, object stores, or distributed filesystems.

The AI subsystem 152 can implement trained machine-learning models, rule-based engines, or hybrid techniques configured to identify ancestral patterns, weigh evidentiary signals, predict dynastic affiliations, and compute or refine confidence values for proposed relationships or royal-density measures. In certain embodiments, the AI subsystem 152 performs entity disambiguation, record linkage, and bias-corrected scoring based on signal quality, provenance, and temporal consistency. Results produced by the AI subsystem 152 may be fed back to the computing subsystem 154 for persistence and visualization.

System 150 interoperates with external or distributed data resources, including a DNA system 160, a genealogy system 170, and a historical system 180. Each external system may be deployed as distinct physical servers, virtual machines (“VMs”), software containers, or cloud services operating in one or more datacenters or local networks. Interfaces between system 150 and external systems 160/170/180 may be implemented as representational state transfer (“REST”) application program interfaces (“APIs”), software development kits (“SDKs”), database connectors, file imports/exports, or secure message queues.

The DNA system 160 includes a DNA computing subsystem 162 and a DNA datastore 164. Subsystem 162 can execute algorithms for haplogroup estimation, segment matching, and kinship inference. Datastore 164 may store raw and processed genetic records, marker annotations, and reference panels. The genealogy system 170 includes a genealogy computing subsystem 172 and a genealogy datastore 174 that maintain structured person records, relationships (e.g., parent-child, spousal), event logs, sources, and imported GEDCOM datasets. The historical system 180 includes a historical computing subsystem 182 and a historical data datastore 184 that manage document images, transcriptions, metadata, authenticity indicators, and jurisdictional context (e.g., parish, county, realm).

During operation, workstation 110 (or another ingestion source) initiates a session and submits selected portions of personal data 120. The edge router 140 authenticates the session and forwards payloads to computing subsystem 154, which writes the received data to staging storage and performs format detection and validation. For structured inputs (e.g., GEDCOM), the system extracts entities and relationships; for documents, the system may perform optical character recognition (“OCR”) or metadata parsing; for DNA files, the system indexes marker sets and haplogroup identifiers. The computing subsystem 154 assigns stable internal identifiers, timestamps, and provenance tags to all ingested objects.

The computing subsystem 154 then orchestrates calls to external systems 160-180 to retrieve corroborating records. Responses are normalized to an internal schema that captures persons, relationships, genetic markers, dynastic identifiers, events, locations, and evidence links with associated provenance and confidence metrics. Normalized data are cached in memory and/or persisted to storage for downstream analysis. In some embodiments, the system maintains versioned datasets so that updates and corrections can be audited and rolled back as needed.

The AI subsystem 152 cooperates with the computing subsystem 154 to transform the unified dataset into structured analytical products. Deterministic routines performed by subsystem 154 include relationship-graph construction, de-duplication heuristics, temporal sanity checks, and overlap detection across maternal and paternal branches. The AI subsystem 152 may perform entity reconciliation, dynasty classification, and confidence scoring using learned weights that take into account overlap counts, genetic correlation strength, historical consistency, and evidence quality. Intermediate results are returned to subsystem 154 for persistence and for rendering by visualization modules (described with reference to later figures).

Inter-component communication within system 150 may use internal APIs, shared queues, or service buses. Requests and responses may be serialized in JavaScript object notation (“JSON”), Protocol Buffers, or other encodings. Security controls can include role-based access, encryption at rest and in transit, audit logging, and data-minimization policies. Where privacy regulations apply, the system can pseudonymize genetic and personal identifiers while maintaining linkability for authorized analytics.

Through this coordinated exchange among workstation 110, edge router 140, system 150, and external systems 160-180, the architecture collects heterogeneous inputs, normalizes them into a consistent schema, and analyzes them using both deterministic and AI-assisted techniques. The resulting verified lineage information and computed metrics are forwarded to downstream visualization and reporting components (see subsequent figures), thereby enabling reproducible royal-lineage discovery grounded in multi-source evidence.

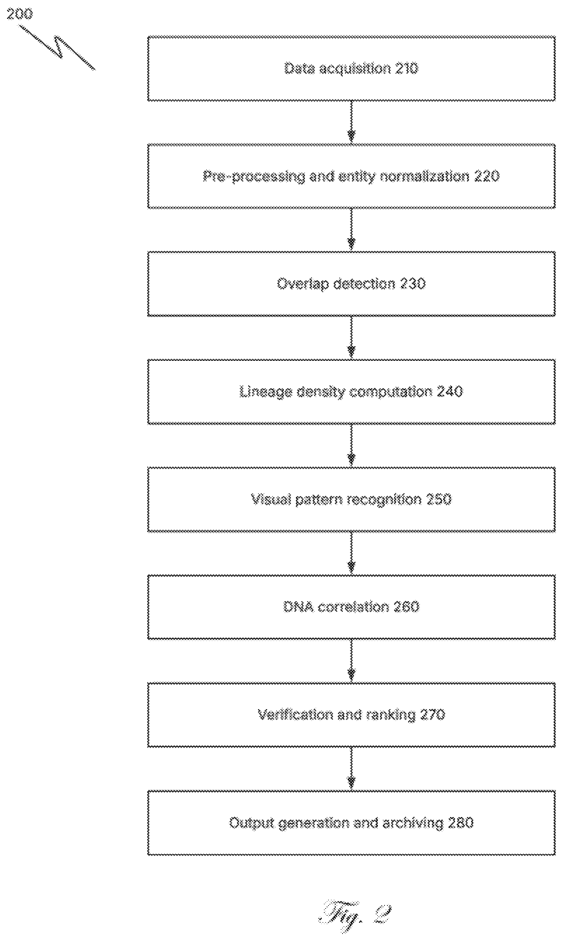

Referring now to FIG. 2, an exemplary operational process 200 executed by the Ancestral Overlap Detection and Visualization System (see FIG. 1) is illustrated. The process shown may be carried out by the computing subsystem and AI subsystem working in coordination and may be implemented in hardware, software, or any combination thereof. Each block of the figure represents a functional stage of the method; the order depicted is illustrative and may vary according to configuration, data availability, or parallel processing optimization.

In step 210, the system receives and aggregates data from a plurality of sources. These include user-supplied personal data (DNA results, genealogical charts, historical documents, and narrative features) and external databases such as the DNA system 160, genealogy system 170, and historical system 180. Data may be imported via APIs, uploaded files, or manual entry through the user interface. During acquisition, metadata such as provenance, file type, encoding, and timestamp are recorded to maintain chain-of-custody and reproducibility. In certain embodiments, differential import handlers automatically classify input files (e.g., GEDCOM or JSON) and assign them to appropriate ingestion pipelines.

At step 220, the system performs data cleaning, standardization, and entity normalization. The computing subsystem parses person names, date formats, location fields, and document references to align with an internal canonical schema. Duplicate records are merged using probabilistic matching; ambiguous entities are assigned unique internal identifiers pending resolution. DNA files are normalized by reference to standardized genomic coordinates (e.g., GRCh38), while genealogical data are normalized to a person-relation graph structure. This step ensures that subsequent analysis stages operate on consistent, machine-readable data regardless of original source or format.

In step 230, the normalized data is examined to identify multi-lineage overlaps—instances in which two or more ancestral lines share common individuals, surnames, geographic loci, or genetic markers. The overlap-detection engine uses a combination of deterministic algorithms (e.g., graph traversal, relational joins) and heuristic or AI-based pattern-matching. Each detected overlap is assigned an initial score reflecting the strength of evidence (genetic, genealogical, or historical) supporting the connection. These scores are propagated through the lineage graph to identify clusters of related families or dynasties.

Following overlap detection, the system computes one or more lineage-density indices at step 240. The lineage-density computation quantifies the degree to which a given person, family, or cluster exhibits convergence toward historically significant lineages, such as royal or dynastic lines. Metrics may include overlap frequency, generational distance, and weighted connection confidence. The computation subsystem normalizes these values to produce a continuous or categorical Royal-Density Index that can be compared across datasets or visualized spatially.

In certain embodiments, lineage-density computation is combined with multi-lineage convergence analysis to identify regions of genealogical overlap representing concentrated ancestral connections to specific dynasties or populations. These regions, referred to as convergence zones, reflect statistically significant clustering of lineage pathways and may be used to prioritize high-confidence ancestry relationships and to visualize inheritance patterns across multiple independent lineage branches.

In step 250, the AI subsystem applies visual pattern-recognition algorithms to interpret relational structures produced by the lineage-density computation. The goal of this stage is not merely to render data but to detect emergent genealogical motifs—such as repeated intermarriage loops, dynastic branches, or convergence funnels—that signify inherited continuity. The subsystem may use unsupervised clustering, graph embeddings, or neural representations of relationship graphs to identify latent patterns that correspond to dynastic or regional inheritance signatures.

In certain embodiments, pattern recognition further includes identification of genealogical clustering based on recurring names, titles, dynastic indicators, and structural patterns within lineage representations. Such identification may be performed through automated analysis, user-guided inspection, or a combination thereof, and may be used to detect candidate lineage clusters prior to computational validation.

The DNA correlation stage 260 integrates genetic information with the inferred genealogical structure. SNP and STR panels (as described earlier) are cross-referenced with identified overlaps and density clusters. The subsystem computes allele-sharing metrics, haplogroup consistency, and expected versus observed recombination probabilities. These correlations are used to validate or adjust lineage hypotheses: strong genetic concordance reinforces a connection, while discrepancies trigger review or re-weighting. When certain features are inferred from medical histories or traits, the subsystem assigns reduced confidence weighting accordingly.

In certain embodiments, genetic correlation includes comparison of user DNA data against ancient DNA samples obtained from archaeological or historical sources. Such comparison may include analysis of single nucleotide polymorphisms (SNPs), haplogroup alignment, genetic distance metrics, and mutation stability indicators, thereby providing an additional validation layer for confirming lineage connections to historically significant populations or individuals.

At step 270, results from previous stages undergo verification and ranking. The verification engine cross-checks computed relationships against known reference lineages, external databases, and internal confidence thresholds. Each lineage hypothesis or dynastic link receives a composite score derived from genetic, genealogical, and historical evidence. The system then ranks the lineages by strength of evidence, relevance, or proximity to royal or notable ancestry. Verification may include both automated consistency checks and user-initiated review processes.

In certain embodiments, the system performs reverse lineage validation by initiating analysis from known historical or reference individuals and tracing lineage paths forward in time to identify intersections with modern genealogical datasets. This bidirectional validation process increases confidence in lineage continuity and reduces false-positive associations.

In the final stage 280, the system produces output artifacts summarizing and visualizing the verified results. Outputs may include lineage-density maps, family-network graphs, ranked tables of ancestral correlations, or detailed reports describing identified overlaps and their supporting evidence. The results are stored in non-transitory computer-readable media for subsequent retrieval, sharing, or integration with future datasets. Archiving routines ensure that version histories, confidence levels, and provenance metadata are preserved to enable reproducibility and longitudinal refinement of results.

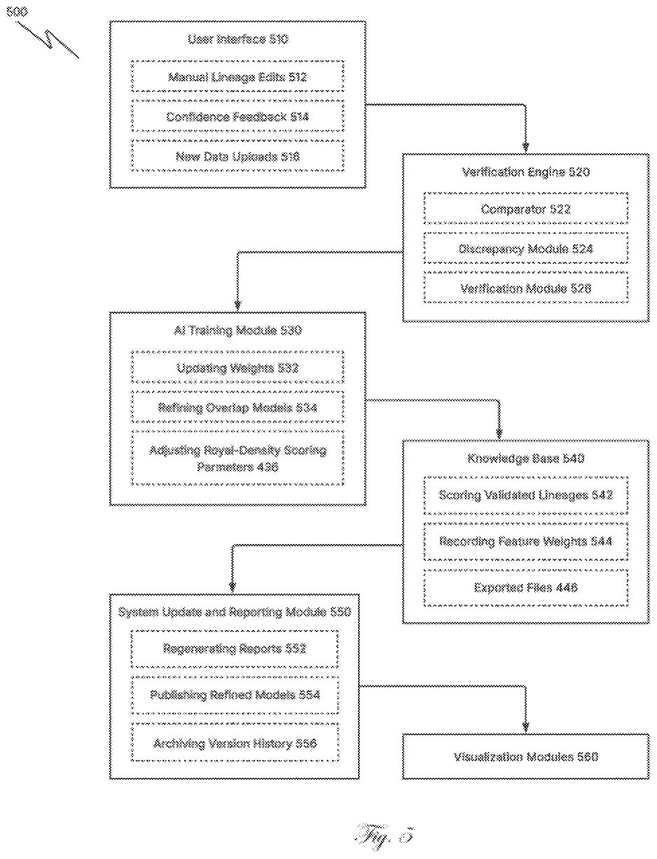

The flow illustrated in FIG. 2 may execute iteratively or in parallel, depending on available computational resources. For example, overlap detection 230 and DNA correlation 260 may operate concurrently on separate processing threads, while lineage-density computation 240 aggregates results asynchronously. The modular design allows the workflow to scale from single-user desktop deployments to multi-node cloud implementations. In some embodiments, intermediate outputs feed into the machine-learning refinement loop described in FIG. 5, allowing continual improvement of accuracy through feedback.

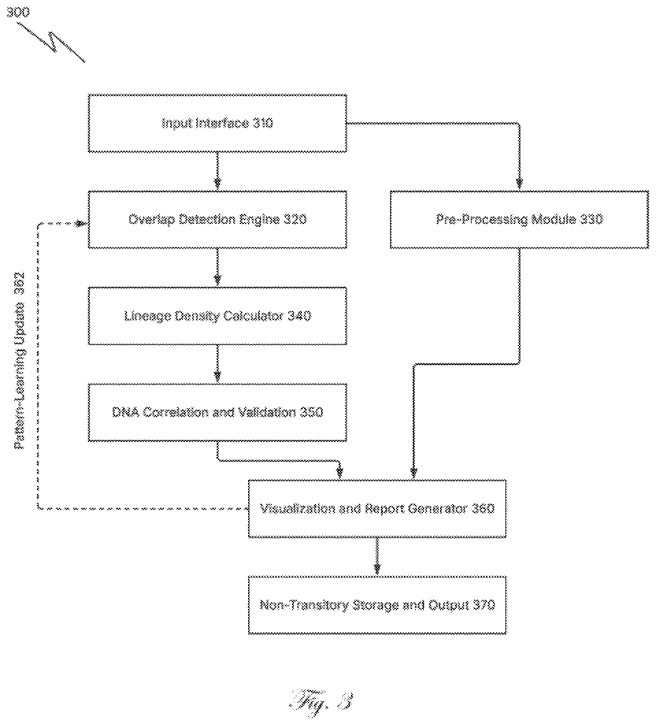

Referring now to FIG. 3, there is shown an exemplary functional block diagram 300 illustrating internal components and data flow within the Ancestral Overlap Detection and Visualization System 150. In one embodiment, the system operates through a modular architecture in which each component performs a discrete set of computational tasks while communicating intermediate results to other modules through standardized interfaces. The process begins at the Input Interface 310, which receives genealogical, historical, and genetic data from the user or external systems. The Input Interface 310 may accept structured files, such as GEDCOMs, variant call formats (“VCFs”), or CSVs, as well as unstructured text, document images, or narrative entries. The interface may include a validation layer that confirms file integrity, verifies expected schema, and records provenance data prior to ingestion.

Data entering the system is transmitted to a Pre-Processing Module 330. The Pre-Processing Module 330 performs entity extraction, data cleaning, and normalization to transform heterogeneous inputs into a consistent internal representation. This may include resolving name variations, standardizing date and place formats, assigning unique identifiers, and normalizing DNA marker references to a defined genomic coordinate system. In some embodiments, the Pre-Processing Module 330 incorporates confidence weighting for inferred or uncertain data and flags inconsistent or incomplete records for later review. Once normalized, the data are passed to analytical engines for further computation.

The Overlap Detection Engine 320 receives the normalized datasets and identifies shared ancestral features between different individuals, families, or dynasties. This engine performs graph-based comparisons to locate duplicate entities, recurring surnames, and shared genealogical structures that suggest overlapping ancestry. In genetic contexts, the engine may detect common SNP or STR markers indicative of relatedness. Each detected overlap is stored as a structured relationship with an associated score representing the strength or likelihood of the match. These overlaps form the foundation for subsequent lineage-density computation.

The Lineage Density Calculator 340 receives the overlap data and computes density metrics describing the extent to which individuals or groups converge toward royal or dynastic lineages. This module quantifies overlap frequency, generational distance, and historical prominence, and produces a Royal-Density Index or equivalent score for each person or lineage. The calculation may be performed using statistical weighting, machine-learning regression, or rule-based logic derived from prior verified datasets. The resulting indices are normalized across the population to allow cross-comparison of different genealogical networks.

The DNA Correlation and Validation module 350 integrates the computed lineage-density results with genetic data. This module correlates SNP and STR profiles, haplogroup assignments, and recombination statistics against inferred genealogical relationships. Matches exhibiting strong genetic concordance increase confidence in the corresponding lineage hypotheses, whereas inconsistent results trigger recalibration or user alerts. The module may also employ Bayesian inference to update confidence probabilities as additional evidence is received, thereby improving validation accuracy over time.

The Visualization and Report Generator 360 aggregates results from the analytical modules and produces human-readable outputs. These may include graphs, hierarchical lineage maps, heat maps of overlap density, and textual reports summarizing relationships, scores, and confidence levels. Visualization and Report Generator 360 also supports user interaction for exploring connections and refining lineage data. In certain embodiments, this module provides a feedback pathway—referred to as Pattern-Learning Update 362—where user-confirmed or corrected results are routed back to the analytical components to refine future model behavior and improve recognition of recurring genealogical structures.

The Non-Transitory Storage and Output module 370 archives the generated outputs and analytical results in durable storage media. Stored materials may include the computed lineage-density metrics, verified genetic correlations, visualization artifacts, and audit logs of all processing steps. The storage layer ensures persistence, reproducibility, and compliance with data-governance requirements. It also supports retrieval for future runs or for integration with external genealogy or research systems. Together, the modules of FIG. 3 provide a cohesive data-processing architecture that enables iterative refinement and machine-assisted verification of lineage relationships through continuous pattern learning and feedback.

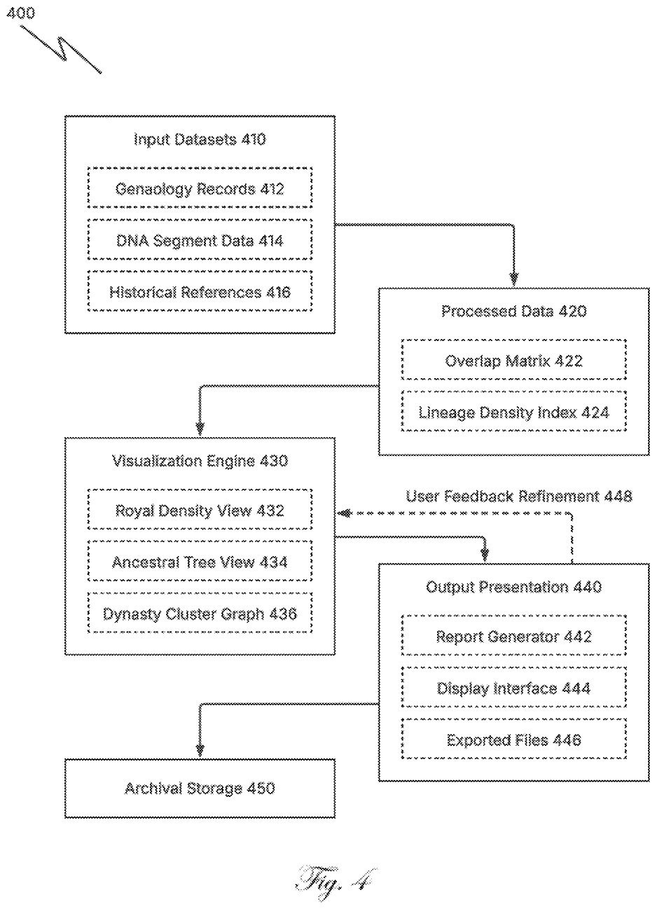

Referring now to FIG. 4, there is shown a representative data-flow diagram 400 illustrating the relationship between input datasets, analytical processing, visualization, and output presentation within the Royal Lineage Discovery System. The system transforms heterogeneous genealogical, genetic, and historical inputs into structured outputs capable of being visualized, verified, and archived. The components illustrated in FIG. 4 may be implemented through the computing and AI subsystems described in FIG. 1 and may execute concurrently or sequentially depending on system configuration.

The process begins with the Input Datasets 410, which include Genealogy Records 412, DNA Segment Data 414, and Historical References 416. Genealogy Records 412 contain structured information such as individual names, dates of birth and death, parentage, spousal relationships, and familial links encoded as relational or graph-based data. These records may be imported from third-party genealogy platforms, local research databases, or manually entered through the user interface. DNA Segment Data 414 represent genetic information derived from full or partial genome analyses, including SNP and STR profiles, haplogroups, and allele-sharing values. Historical References 416 encompass corroborating materials such as royal lineage charts, heraldic registries, land titles, wills, or contemporaneous documents that support the existence or significance of a dynastic relationship. Each of these datasets may include metadata indicating source provenance, confidence level, and acquisition date.

Once received, the data are transformed into Processed Data 420, which comprises two major internal artifacts: the Overlap Matrix 422 and the Lineage Density Index 424. The Overlap Matrix 422 stores pairwise or multi-way relationships among individuals, representing shared ancestors, geographic overlaps, and genetic affinities. Each cell of the matrix may include computed metrics such as connection value, generational separation, and marker concordance. The Lineage Density Index 424 provides a numerical quantification of how densely connected an individual or group is to known dynastic or royal lineages, calculated using weighted genealogical, historical, and genetic criteria. The combination of these structures forms the analytical foundation for subsequent visualization and reporting.

The Processed Data 420 is communicated to a Visualization Engine 430, which generates interpretable visual models of the computed relationships. The Visualization Engine 430 includes several specialized rendering views. The Royal Density View 432 graphically displays the intensity or concentration of dynastic connections, often as a heat map or weighted graph emphasizing clusters of high royal lineage density. The Ancestral Tree View 434 produces hierarchical trees or network diagrams showing individual-to-ancestor relationships with annotated confidence levels and overlap markers. The Dynasty Cluster Graph 436 identifies interlinked family groups, showing how multiple lineages merge or diverge across time. Collectively, these visualizations allow researchers or users to perceive patterns that are not immediately apparent in raw data form.

The results from Visualization Engine 430 are transmitted to an Output Presentation module 440. This module formats and delivers analysis results in accessible forms suitable for display, sharing, or archival. The Output Presentation module 440 includes a Report Generator 442 that produces narrative and tabular summaries describing identified overlaps, computed indices, and confidence levels. A Display Interface 444 provides real-time visualization through the user interface, enabling interactive exploration of results, adjustment of display parameters, and on-demand recalculation of filtered subsets. The Exported Files component 446 allows users to download or transmit results in common formats such as PDF, CSV, JSON, or image files, enabling integration with external systems or offline analysis.

A feedback mechanism, represented as User Feedback Refinement 448, connects the Output Presentation 440 back to the visualization and analytical stages. When users adjust or annotate visualizations, confirm relationships, or correct errors, these actions are recorded as feedback data. The system incorporates these refinements to recalibrate weighting parameters or retrain AI models, thereby improving the accuracy and responsiveness of future computations. This closed-loop refinement process ensures that the analytical model remains aligned with verified historical and genealogical knowledge.

The final component, Archival Storage 450, preserves all results, visualizations, and associated metadata for long-term retrieval and reproducibility. Archival Storage 450 maintains both input and processed data, as well as version histories of analytical models and generated reports. The archived datasets may be encrypted, indexed, and timestamped to support regulatory compliance, academic research standards, or proprietary data protection requirements. In some embodiments, archived outputs are cross-referenced with external data repositories to ensure traceability and continued accessibility as source databases evolve.

Together, the components shown in FIG. 4 define a continuous data-processing and visualization pipeline that begins with raw genealogical, genetic, and historical information and ends with verified, interpretable lineage outputs. The architecture supports iterative refinement through user feedback, automated recalibration, and persistent storage, thereby enabling the accurate and evolving discovery of royal or dynastic ancestry across diverse datasets.

Referring now to FIG. 5, there is shown an exemplary feedback and refinement architecture 500 for the Royal Lineage Discovery System, illustrating how user interactions, verification routines, and AI model updates cooperate to continuously improve lineage accuracy and confidence scoring. The architecture represents an iterative learning loop in which verified outcomes and new data contribute to the ongoing enhancement of analytical performance and interpretive precision.

The process begins at the User Interface 510, through which end users, researchers, or authorized administrators interact with the system. The User Interface 510 provides multiple modes of input and control. The Manual Lineage Edits function 512 enables users to correct genealogical entries, resolve ambiguous relationships, or manually link individuals whose relationships are supported by external evidence. Confidence Feedback 514 allows users to assign subjective confidence ratings or validation flags to computed relationships, overlap clusters, or lineage-density scores. New Data Uploads 516 provide a mechanism for users to supply additional genealogical, DNA, or historical datasets, thereby expanding the available corpus for analysis. Collectively, these user-driven actions form the foundation for the learning and verification cycle.

Data and feedback from the User Interface 510 are communicated to a Verification Engine 520, which is responsible for validating the integrity and accuracy of the computed results. The Verification Engine 520 includes a Comparator 522 that performs pairwise and multi-level comparisons between newly computed relationships and reference data derived from established genealogical or genetic repositories. Discrepancy Module 524 identifies inconsistencies, conflicts, or anomalies among datasets, flagging them for human or automated review. The Verification Module 526 applies validation rules, threshold checks, and statistical confidence testing to determine whether a given lineage or ancestral claim meets the minimum criteria for acceptance into the system's verified corpus. Through these subsystems, the Verification Engine 520 functions as a quality-control gate ensuring that only reliable and reproducible data influence model training.

Validated results and discrepancy reports are transmitted to the AI Training Module 530, where machine-learning components update analytical parameters based on verified outcomes and detected deviations. The AI Training Module 530 includes Updating Weights 532, which modifies internal neural or statistical weight distributions in response to feedback data. The Refining Overlap Models component 534 adjusts the algorithms that detect multi-lineage overlaps to improve their sensitivity and specificity in future analyses. Adjusting Royal-Density Scoring Parameters 536 fine-tunes the metrics and thresholds that govern how the system quantifies dynastic concentration and relatedness. This process allows the AI subsystem to incrementally learn from verified examples, reducing false positives and enhancing interpretive robustness over time.

The refined models and updated analytical parameters are stored within a Knowledge Base 540. The Knowledge Base 540 includes a Scoring Validated Lineages function 542 that maintains authoritative lineage associations and assigns calibrated confidence values to each. Recording Feature Weights 544 captures the relative importance of genetic, genealogical, and historical attributes contributing to lineage validation, allowing the system to document the reasoning behind specific determinations. The Exported Files element 546 facilitates the distribution of updated model weights, validation summaries, or lineage datasets for replication or integration into external systems. The Knowledge Base 540 thus serves as a persistent repository of verified lineage intelligence that both informs current analyses and trains future ones.

Outputs from the AI Training Module 530 and Knowledge Base 540 feed into a System Update and Reporting Module 550. This module automates the process of incorporating newly refined models into production workflows and maintaining comprehensive version control. The Regenerating Reports function 552 triggers the re-creation of analytical and visual outputs using the updated models, ensuring that all results reflect the most recent improvements. The Publishing Refined Models component 554 releases validated and retrained model versions to the active system environment or connected research nodes. Archiving Version History 556 preserves earlier versions of analytical models, enabling rollback, auditability, and compliance with scientific reproducibility standards.

The final stage of the loop involves Visualization Modules 560, which receive updated outputs and present them to users for review. These visualization modules render the latest verified results, showing revised confidence scores, re-ranked dynastic connections, and visual differences between current and prior iterations. This immediate feedback allows users to see how their contributions and newly incorporated data influence the system's analytical conclusions.

Through this cyclical architecture, FIG. 5 demonstrates how user feedback, verification processes, and adaptive learning cooperate to create a continuously self-improving system. Each cycle of data entry, verification, model adjustment, and visualization further refines the underlying analytical framework, ensuring that royal-lineage discoveries remain accurate, explainable, and dynamically responsive to newly available genealogical and genetic evidence.

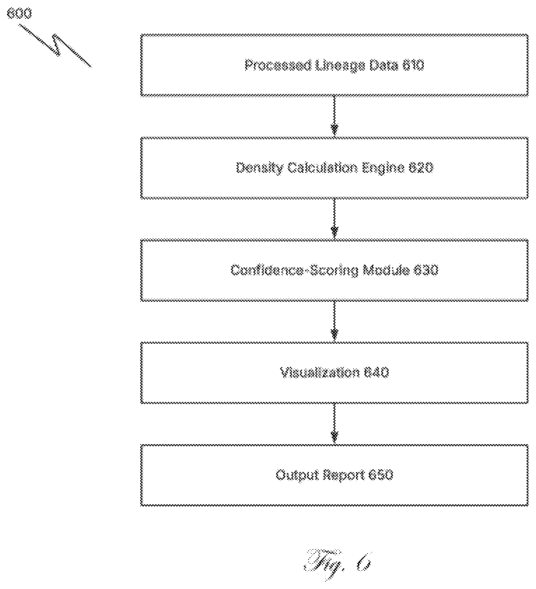

Referring now to FIG. 6, there is shown a process flow 600 illustrating an exemplary computational pipeline for calculating and visualizing lineage density metrics within the Royal Lineage Discovery System. This process transforms verified genealogical and genetic data into a quantified confidence score and generates graphical and textual outputs for interpretation and reporting. The sequence of steps depicted is representative, and in various embodiments, some operations may execute in parallel, be combined, or occur asynchronously depending on system configuration and dataset complexity.

The process begins with the acquisition of Processed Lineage Data 610. These data may originate from prior analytical stages described in earlier figures, such as overlap detection, normalization, and verification. Processed Lineage Data 610 includes individual and familial identifiers, connection weights, genetic markers, and historical correlations that have been prevalidated and indexed for computational efficiency. In some embodiments, the dataset may also include metadata indicating source reliability, temporal depth, and prior confidence ratings. The system retrieves this dataset from active memory or archival storage and prepares it for quantitative analysis.

At the next stage, the data are transmitted to the Density Calculation Engine 620. The Density Calculation Engine 620 computes the degree of interconnectedness within the lineage network using algorithmic techniques such as graph analysis, weighted clustering, and proximity-based scoring. The computation may consider the number of shared ancestors, the generational distance between connections, and the cumulative overlap of verified dynastic affiliations. The resulting measure, referred to as the Lineage Density Index, represents the concentration of ancestral ties to recognized noble or royal families. The Density Calculation Engine 620 may normalize the computed values across the total population analyzed, providing comparative context for different individuals or families.

The Confidence-Scoring Module 630 receives the computed density metrics and applies statistical and machine-learning techniques to determine a composite confidence value for each lineage hypothesis. This score integrates multiple dimensions of evidence, including genetic correlation strength, historical consistency, and the completeness of genealogical documentation. In some embodiments, the module employs Bayesian updating or regression-based weighting to balance strong but sparse evidence against weaker but more abundant corroboration. Confidence scores may be expressed as normalized percentages, ordinal ranks, or categorical levels (e.g., low, medium, high confidence). The system uses these values to determine which results are promoted for visualization or flagged for further verification.

The Visualization 640 stage transforms the quantitative results into human-readable forms suitable for review and presentation. The visualization may include network graphs illustrating lineage interconnections, geographic maps showing regional clustering, or heat maps highlighting royal-density concentrations. Additional visualization formats may include ancestral trees, radial diagrams, or temporal timelines that depict the evolution of dynastic links over generations. The visualization subsystem supports dynamic scaling, user interaction, and filtering to allow exploration of specific lineages or confidence thresholds.

The final stage, Output Report 650, compiles and exports the results in both graphical and textual formats. The Output Report 650 includes detailed summaries of each evaluated individual or family, their computed density values, and associated confidence levels. Reports may further include lists of overlapping lineages, key contributing historical documents, and supporting genetic markers. The generated output may be stored in non-transitory computer-readable media and optionally exported in common formats such as PDF, extensible markup language (“XML”), or JSON for external review or integration with third-party genealogical software. Each report is tagged with a version identifier and timestamp to ensure traceability and reproducibility.

Throughout the operation of process 600, the system may monitor intermediate results and automatically trigger recalculations or feedback updates when new data are introduced. This ensures that the lineage-density calculations remain current as additional evidence or user edits are incorporated. By combining quantitative analysis, statistical scoring, and interpretive visualization, the workflow shown in FIG. 6 enables objective, transparent, and reproducible assessment of genealogical significance and royal lineage correlation.

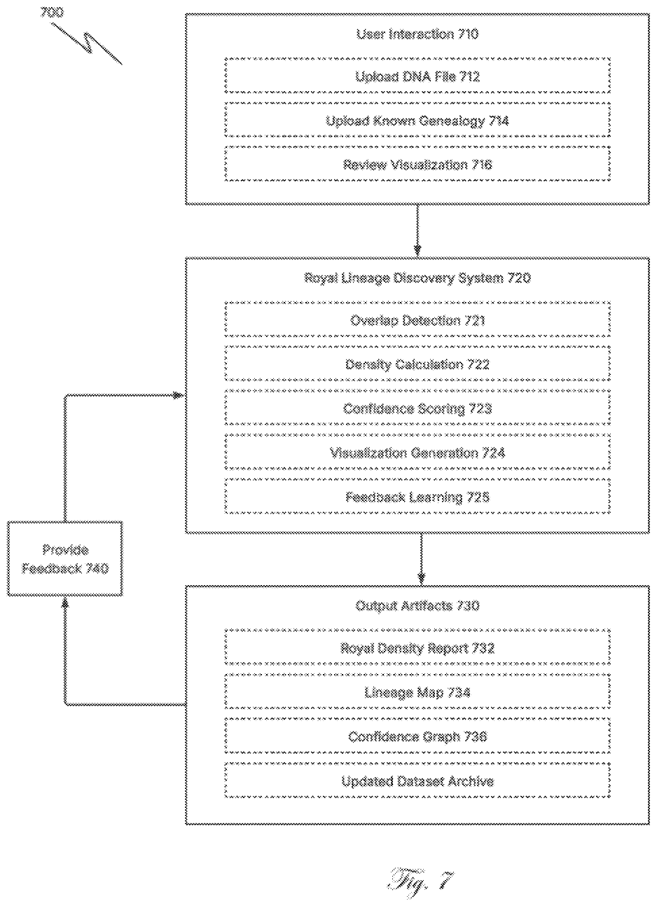

Referring now to FIG. 7, there is shown an exemplary end-to-end interaction flow 700 illustrating how users interface with the Royal Lineage Discovery System, how analytical processing occurs, and how results and feedback are exchanged to refine the system's accuracy and responsiveness. The diagram demonstrates the complete life cycle of data—from user input to analytical processing, output generation, and iterative learning based on feedback.

The process begins at the User Interaction module 710, which provides the primary interface between the system and end users. The Upload DNA File function 712 enables users to provide raw or processed genetic data for analysis. These files may include full-genome sequences, SNP and STR profiles, or haplogroup reports generated by third-party testing services. The Upload Known Genealogy function 714 allows users to submit structured genealogical data, such as GEDCOM files, pedigree charts, or family records obtained from research databases. These files serve as the genealogical baseline against which genetic and historical evidence are compared. The Review Visualization component 716 allows users to view intermediate or final outputs, including charts, graphs, and hierarchical trees that illustrate how their ancestry connects to other lineages or dynastic clusters.

Data collected through the user interface are transmitted to the Royal Lineage Discovery System 720, which performs the computational and analytical tasks necessary to generate meaningful results. Within this system, the Overlap Detection module 721 identifies intersections among genealogical records, genetic markers, and historical references, mapping common ancestry and shared lineage events. The Density Calculation module 722 computes the lineage-density index, quantifying how strongly a given individual or family converges toward verified dynastic or royal ancestry. The Confidence Scoring module 723 applies algorithmic evaluation to determine the reliability of inferred connections, weighing evidence strength across multiple data domains. The Visualization Generation module 724 translates computed metrics and relationships into interpretable formats, such as network graphs, density maps, and timeline visualizations. The Feedback Learning module 725 monitors user interactions, verification results, and new data additions to improve subsequent model behavior through adaptive refinement.

After the analytical processes are completed, the system produces Output Artifacts 730 that encapsulate the results in structured, accessible forms. These outputs include a Royal Density Report 732, which summarizes lineage-density scores, dynastic affiliations, and supporting evidence; a Lineage Map 734, which visually depicts ancestral paths and convergence points toward royal bloodlines; a Confidence Graph 736, which charts reliability and data strength across all analyzed connections; and an Updated Dataset Archive 738, which stores the processed and normalized data for future retrieval or re-analysis. Each artifact includes metadata identifying version history, data sources, and computation parameters to ensure traceability and scientific reproducibility.

Users are then invited to Provide Feedback 740 based on their review of the generated artifacts. Feedback may include manual edits to genealogical data, confirmation or rejection of suggested relationships, or the addition of new evidence such as historical citations or DNA updates. This feedback is transmitted back into the Royal Lineage Discovery System 720, where it is used to retrain the learning models, refine scoring parameters, and correct identified discrepancies. Over time, the incorporation of user feedback allows the system to adapt dynamically to new information and evolving datasets, reducing errors and improving predictive precision.

The cyclical loop between User Interaction 710, Royal Lineage Discovery System 720, Output Artifacts 730, and Feedback 740 represents a continuous improvement process. As verified data accumulate and feedback is integrated, the system's knowledge base expands, and its inference models become increasingly accurate in identifying and confirming ancestral connections. The result is an evolving analytical framework that becomes more precise and context-aware with each iteration. The flow illustrated in FIG. 7 thus provides a complete operational overview of how data are entered, analyzed, visualized, and refined to support verifiable royal-lineage discovery through adaptive, user-informed machine learning.

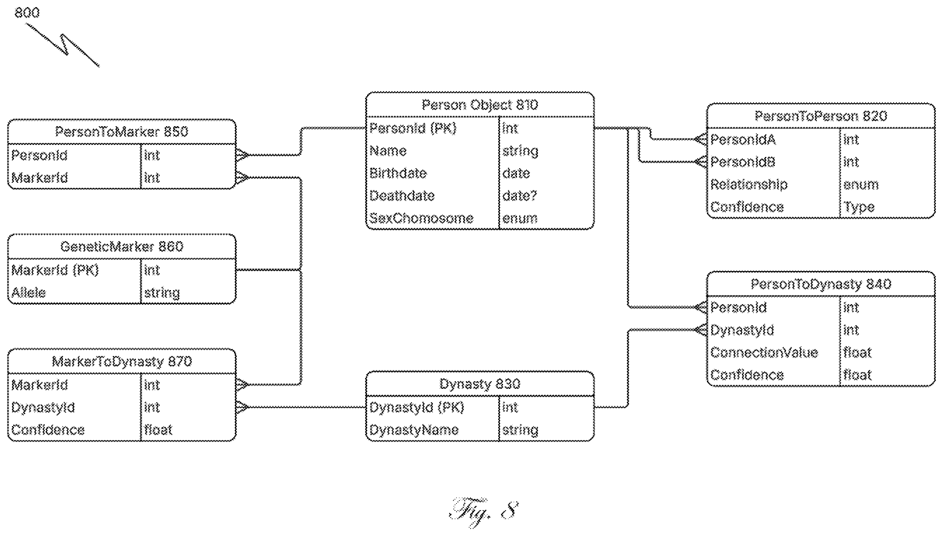

Referring now to FIG. 8, there is shown a data model 800 representing one embodiment of the relational architecture used to store and correlate genealogical, genetic, and dynastic data within the Royal Lineage Discovery System. The illustrated schema provides a structured representation of how individuals, genetic markers, dynasties, and their interrelationships are recorded, scored, and cross-linked to enable computational analysis of ancestral lineage and royal descent probabilities.

At the center of the schema is the Person Object 810, which represents the fundamental entity corresponding to an individual in the genealogical system. Each record in the Person Object 810 includes a PersonId (Primary Key) uniquely identifying the individual, a Name field for recorded or inferred identity, and temporal attributes such as Birthdate and optional Deathdate, where available. The SexChromosome field is an enumerated value (e.g., XX, XY, or other) that provides biological sex information inferred from DNA data or self-reported genealogical information. The Person Object 810 serves as the core reference point for associating individuals with DNA evidence, familial relationships, and dynastic affiliations.

The PersonToPerson table 820 establishes direct relationships between individuals. It links PersonIdA and PersonIdB, defining the type of familial relationship via the Relationship field, which may include enumerated values such as “parent,” “child,” “sibling,” or “spouse.” Each link also carries a Confidence value representing the reliability or strength of evidence supporting that connection, allowing both verified and hypothesized relationships to coexist in the dataset. The PersonToPerson table thus enables network-style mapping of familial structures with quantified trust values.

The Dynasty table 830 defines distinct dynastic or royal lineages recognized by the system. Each entry includes a unique DynastyId (Primary Key) and a DynastyName string that identifies the lineage, such as “House of Habsburg” or “Plantagenet.” These records serve as anchor nodes against which individuals and genetic features can be associated or scored to determine the extent of royal or noble ancestry.

The PersonToDynasty table 840 maps individuals to dynastic groups, linking PersonId to DynastyId and associating each connection with a ConnectionValue and a Confidence metric. The ConnectionValue quantifies the degree of genetic or genealogical overlap—such as the proportion of shared markers, generational proximity, or inferred descent probability—while the Confidence score represents the statistical certainty or model-based likelihood of that association. This table enables the computation of “royal density” or dynastic affiliation strength across individuals and populations.

The GeneticMarker table 860 defines discrete DNA features used for analysis. Each MarkerId (Primary Key) identifies a specific genetic locus, and the Allele field stores the observed nucleotide sequence, variant, or STR profile associated with that marker. These genetic markers may correspond to SNPs, microsatellites, or other genomic regions relevant to ancestry inference. By indexing and cross-referencing these markers, the system can evaluate genetic similarity and inheritance patterns across individuals and dynasties.

The PersonToMarker table 850 represents a many-to-many relationship linking individuals to their corresponding genetic markers. Each record includes a PersonId and MarkerId, signifying that a given person exhibits a particular marker. This table allows flexible integration of complete genome sequences or partial panels, such as Y-DNA, mtDNA, or autosomal test results, enabling diverse data sources to contribute to the overall lineage model.

The MarkerToDynasty table 870 links specific genetic markers to dynastic lineages, representing population-level correlations. Each record connects a MarkerId to a DynastyId and includes a Confidence value quantifying how strongly that genetic feature is statistically associated with members of the dynasty. This mapping supports inference of dynastic affiliation even in cases where genealogical documentation is incomplete or unavailable. When a genetic marker found in a person is also strongly associated with a dynasty, the system uses this information to increase the individual's dynastic confidence score.

In operation, the relationships among these tables form an integrated analytical framework. The Person Object 810 connects through multiple relational paths: (i) genealogical relationships via PersonToPerson 820, (ii) genetic features via PersonToMarker 850 and GeneticMarker 860, and (iii) dynastic affiliations via PersonToDynasty 840 and MarkerToDynasty 870. These linkages allow the Royal Lineage Discovery System to correlate genetic, genealogical, and historical evidence across both individual and group levels.

In some embodiments, this relational architecture is implemented in a distributed database system that supports scalable querying and real-time analysis. The schema can reside in a cloud-based environment, a local data warehouse, or within a virtualized infrastructure, such as containers or VMs, allowing parallel computation across large population datasets. The relational joins between tables enable high-performance lineage scoring, cluster analysis, and inferential modeling, forming the structural backbone of the AI-driven ancestral overlap and royal-density detection framework.

In some embodiments, the database schema shown in FIG. 8 operates as an adaptive and iterative system, dynamically updating as new individuals are analyzed and as confidence metrics evolve. As more users contribute DNA or genealogical data, the relational tables—particularly PersonToDynasty 840, PersonToMarker 850, and MarkerToDynasty 870—are recalibrated to reflect the increased statistical weight of recurring genetic or lineage patterns. When a person's ConnectionValue or Confidence score in PersonToDynasty 840 is adjusted upward due to new evidence linking them to a dynasty, related individuals connected through the PersonToPerson 820 table may also experience proportional adjustments to their own scores, representing inferred ancestral proximity. Similarly, when a marker previously associated with a dynasty is discovered in multiple new individuals with verified ties, the MarkerToDynasty 870 confidence value may increase, thereby improving the overall precision of royal correlation. This iterative feedback mechanism allows the system to continuously refine its inference model, enabling dynamic propagation of confidence updates across familial and genetic networks as the database expands.

Thus, the data model of FIG. 8 provides a normalized, extensible foundation for managing diverse data types—genetic, genealogical, and dynastic—and for quantifying their interrelationships in a manner that supports transparent, verifiable, and computationally efficient royal lineage discovery.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples,” “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples,” “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

1. A system for determining ancestral relationships and generating lineage-density evaluations, comprising:
a computing system including a processor and a memory storing executable instructions;
one or more input modules configured to receive input data associated with at least one person of interest, the input data comprising genetic information and at least one of genealogical information, personal narrative information, and historical information;
one or more processing modules executable by the computing system to:
(i) normalize the genealogical information, the personal narrative information, and the historical information;
(ii) identify overlap among ancestral entities; and
(iii) generate one or more lineage-density values indicating relational proximity between the person of interest and one or more population groups;
a correlation module executable by the computing system configured to compare genetic data from the person of interest to reference data associated with one or more population groups and generate confidence scores of probable lineage; and
an output module configured to generate a report or visualization representing the lineage-density values and confidence scores.

2. The system of claim 1, wherein the input data comprises genealogical information, wherein the genealogical information is compared to information stored in a genealogical datastore as part identifying overlap among ancestral entities.

3. The system of claim 1, wherein the processing modules are configured to perform a sequence of operations comprising data acquisition, entity normalization, overlap detection, lineage-density computation, correlation with genetic data, and verification and output generation.

4. The system of claim 1, wherein the output module includes a feedback interface configured to receive user input adjusting or confirming relationship confidence, the feedback interface being coupled to the processing modules to update one or more weighting parameters.

5. The system of claim 1, wherein the computing system further executes an adaptive training module configured to update correlation parameters, refine overlap models, and adjust scoring weights based on verification of lineage data.

6. The system of claim 1, wherein the processing modules include a density-calculation engine and a confidence-scoring component configured to produce ranked lineage reports.

7. The system of claim 1, wherein the computing system maintains relational data structures linking persons, genetic markers, and dynasties.

8. The system of claim 7, further comprising updating one or more datastores when links are found between the person of interest and other people, genetic markers, or dynasties.

9. One or more non-transitory computer-readable media storing instructions that, when executed by a computing system comprising at least one processor, cause the computing system to:
receive input data associated with at least one person of interest, the input data comprising genetic information and at least one of genealogical information, personal narrative information, and historical information;
normalize the genealogical information, the personal narrative information, and the historical information;
identify overlap among ancestral entities;
generate one or more lineage-density values indicating relational proximity between the person of interest and one or more population groups;
compare genetic data from the person of interest to reference data associated with one or more population groups;
generate confidence scores of probable lineage; and
generate a report or visualization representing the lineage-density values and confidence scores.

10. The non-transitory computer-readable media of claim 9, wherein the instructions further cause the computing system to compare genealogical information contained within the input data to data stored in a genealogical datastore as part of the operation to identify overlap among ancestral entities.

11. The non-transitory computer-readable media of claim 9, wherein the instructions further cause the computing system to perform a sequence of operations comprising data acquisition, entity normalization, overlap detection, lineage-density computation, correlation with genetic data, and verification and output generation.

12. The non-transitory computer-readable media of claim 9, wherein the instructions further cause the computing system to receive user input confirming or adjusting relationship confidence and to update one or more weighting parameters used in computing the confidence scores based on the received input.

13. The non-transitory computer-readable media of claim 9, wherein the instructions further cause the computing system to execute an adaptive training routine that updates correlation parameters, refines overlap-detection models, and adjusts scoring weights based on verification of lineage data.

14. The non-transitory computer-readable media of claim 9, wherein the instructions further cause the computing system to maintain relational data structures linking persons, genetic markers, and dynasties, and to update one or more datastores when new links are identified between the person of interest and other people, genetic markers, or dynasties.

15. A method for determining ancestral relationships and generating lineage-density evaluations, comprising:
receiving input data associated with at least one person of interest, the input data comprising genetic information and at least one of genealogical information, personal narrative information, and historical information;
normalizing the genealogical information, the personal narrative information, and the historical information;
identifying overlap among ancestral entities based on the normalized information;
generating one or more lineage-density values indicating relational proximity between the person of interest and one or more population groups;
comparing genetic data from the person of interest to reference data associated with one or more population groups to generate confidence scores of probable lineage; and
generating a report or visualization representing the lineage-density values and confidence scores,
wherein the method is carried out by one or more computer processors.

16. The method of claim 15, further comprising comparing the genealogical information to information stored in a genealogical datastore as part of the identifying of overlap among ancestral entities.

17. The method of claim 15, further comprising performing a sequence of operations comprising data acquisition, entity normalization, overlap detection, lineage-density computation, correlation with genetic data, and verification and output generation.

18. The method of claim 15, further comprising receiving user input confirming or adjusting relationship confidence and updating one or more weighting parameters used to calculate the confidence scores based on the received input.

19. The method of claim 15, further comprising executing an adaptive training process that updates correlation parameters, refines overlap-detection models, and adjusts scoring weights based on verification of lineage data.

20. The method of claim 15, further comprising maintaining relational data structures linking persons, genetic markers, and dynasties, and updating one or more datastores when new links are identified between the person of interest and other people, genetic markers, or dynasties.
